(19) United States
(12) Patent Application Publication
(10) Pub. No.: US 2012/0278729 A1
(43) Pub. Date: Nov. 1, 2012

(54) METHOD OF ASSIGNING USER INTERACTION CONTROLS

(76) Inventors: Ramadevi Vennelakanti, Bangalore (IN); Prasenjit Dey, Bangalore (IN); Sriganesh Madhvanath, Bangalore (IN); Anbumani Subramanian, Bangalore (IN); Dinesh Mandalapu, Bangalore (IN)

(21) Appl. No.: 13/458,909

(22) Filed: Apr. 27, 2012

(30) Foreign Application Priority Data
Apr. 27, 2011 (IN) 1454/CHE/2011

(51) Int. Cl. G06F 3/048

(52) U.S. Cl. 715/750

(57) ABSTRACT

Provided is a method of assigning user interaction controls. The method assigns, in a scenario where multiple co-present users are simultaneously providing user inputs to a computing device, a first level of user interaction controls related to an object on the computing device to a single user and a second level of user interaction controls related to the object to all co-present simultaneous users of the computing device.

### BACKGROUND

Most computing devices are designed and configured for a single user. Whether it is a desktop computer, a notebook, a tablet PC or a mobile device, the primary input interaction is meant for only one individual. In case multiple users intend to use a device, the user input is typically provided either sequentially or routed through the primary user. Needless to say, this may mar the experience for all other users.

Development of new modes of interaction, such as touch, voice, gesture, etc., has given rise to the possibility of multiple users interacting with a single device. Since these interaction paradigms do not require a distinct input accessory, such as a mouse or a keyboard, a device supporting multimodal interaction may allow multiple users to provide their inputs. For instance, a device with hand gestures recognition capability may receive gesture inputs from more than one user. In such scenario, the computing device may have to deal with simultaneous user inputs related to an object at a given point in time.

### BRIEF DESCRIPTION OF THE DRAWINGS

For a better understanding of the solution, embodiments will now be described, purely by way of example, with reference to the accompanying drawings, in which:

FIG. 1 shows a flow chart of a method of assigning user interaction controls related to an object, according to an embodiment.

FIG. 2 shows an example of assigning user interaction controls related to an object, according to an embodiment.

FIG. 3 shows a block diagram of a user's computing system, according to an embodiment.

### DETAILED DESCRIPTION OF THE INVENTION

As mentioned earlier, computing devices are increasingly moving away from traditional input devices, such as a keyboard, to new interaction modes, such as touch, speech and gestures. These new interaction means are more engaging and natural to humans than the earlier accessory based input devices. Apart from providing a more instinctive human-machine communication, multimodal interaction also provides an option to a computing device to receive simultaneous inputs from multiple users at the same time. It is not difficult to contemplate that it is far easier for multiple users to provide their individual inputs at the same time by speech (touch or gesture, for that matter), rather than through a keyboard, a mouse, a track pad or a remote.

However, traditional input devices have an advantage. In a multiuser single device scenario, an input accessory streamlines multiple user inputs before passing them to the computing device. The user inputs are entered sequentially, thus avoiding conflict. On the other hand, in a multimodal interaction based system (presumably, without a traditional input device), simultaneous inputs from more than one user may lead to a chaotic situation, especially if multiple user inputs are directed towards the same object on the computing device. For instance, let's consider a media player application on a computing device which provides a playlist option for a user to select a song from the list. In the event there are multiple users present, simultaneous input commands from various users for selecting a song of their choice might lead to a situation where it could become difficult for the device to recognize a genuine “selection” command. Needless to say, this is not a desirable situation.

Therefore, to maintain order and avoid chaos possible in a scenario, as described, it is relevant that a computing system be able to manage interaction controls related to objects present therein in a non-conflicting manner, especially in a user group scenario where multiple and simultaneous commands might be directed at the same object.

Embodiments of the present solution provide a method and system for assigning user interaction controls related to an object on a computing device.

For the sake of clarity, the term “object”, in this document, is meant to be understood broadly. The term may include any data, content, entity or user interface element present in a computing device. By way of example, and not limitation, an “object” may include a media object, such as, text, audio, video, graphics, animation, images (such as, photographs), multimedia, or a menu item and the like.

Also, in this document, the term “user” may include a “consumer”, an “individual”, a “person”, or the like.

Further, the term “control”, in this document, is also meant to be understood broadly. The term includes any kind of manipulation that may be carried out in relation to an “object” present on a computing device. The manipulation may involve by way of example, and not limitation, creation, deletion, modification or movement of an object either within the computing system itself or in conjunction with another computing device which may be communicatively coupled with the first computing system. Also, in this regard, the expression “interaction control” includes object controls that pertain to a user's interaction or engagement with an object.

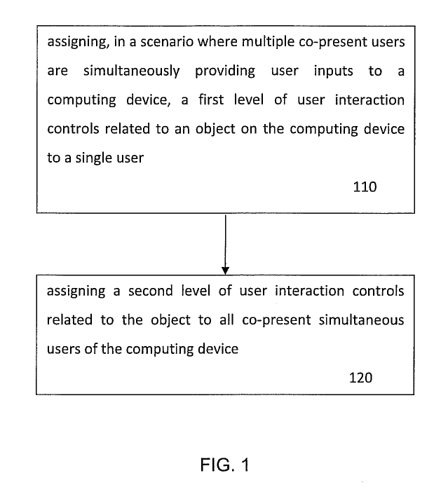

FIG. 1 shows a flow chart of a method of assigning user interaction controls related to an object, according to an embodiment.

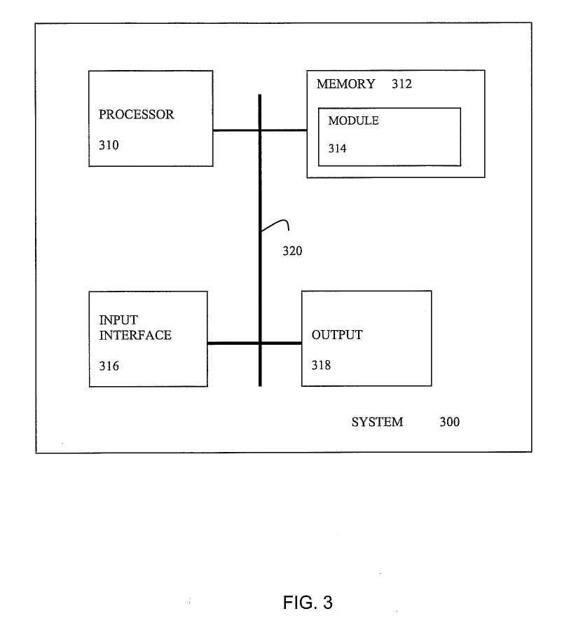

The method may be implemented on a computing device (system), such as, but not limited to, a personal computer, a desktop computer, a laptop computer, a notebook computer, a network computer, a personal digital assistant (PDA), a mobile device, a hand-held device, a television (TV), a music system, or the like. A typical computing device that may be used is described further in detail subsequently with reference to FIG. 3.

Additionally, the computing device may be connected to another computing device or a plurality of computing devices via a network, such as, but not limited to, a Local Area Network (LAN), a Wide Area Network, the Internet, or the like.

Referring to FIG. 1, block 110 involves assigning, in a scenario where multiple co-present users are simultaneously providing user inputs to a computing device, a first level of user interaction controls related to an object on the computing device to a single user.

In an example, the proposed method contemplates a scenario where a computing device is being used by more than one user at the same time. The users could be conceived to be co-present as a group, with each user either providing or aiming to provide his or her user input to the computing device. The device is enabled to recognise and identify user(s). Therefore, if multiple users are co-present, the device is able to recognize and identify each user.

The user input could be related to an object present on the device which a user(s) would like to control as per his or her choice. Therefore, at any given point in time there's a possibility that the computing device might receive simultaneous multiple inputs from co-present users.

In an example, once the computing device recognizes the co-presence of multiple simultaneous users, it divides interaction controls related to an object under user interaction (or based on user selection) into multiple levels. A first level of user interaction controls related to the object under interaction on the computing device is assigned to a single user. To provide an illustration, let's assume that a gaming application (object) is being played on a display coupled to a computing device. The gaming application may comprise a Graphical User Interface (GUI) that illustrates user interaction controls related to the game's functioning on the display as well. Some of the user interaction controls may include, by way of illustration, a play function, a pause function, a stop function, a colour (of an object) selection function and a sound selection function. Upon identification of the user interaction controls related to an object (gaming application), the proposed method divides the related controls into multiple levels. In the present instance, a first level of user interaction controls may be created that may include functions, such as, play, pause and stop. Another level of controls may be created to include remaining or some other functions. In this manner, interaction controls related to an object are divided into multiple levels. And once various levels of user interaction controls are formed, a first level of user interaction controls related to an object is assigned to a single user from the group identified earlier. In the present example, a first level of user interaction controls that include functions, such as, play, pause and stop, is assigned to a single user amongst other co-present users.

In an example, the first level of user interaction controls includes disruptive controls, which are capable of interrupting a user's interaction with the object. The disruptive controls might be labelled “Keyntrols”. The disruptive controls may include commands related to opening of an object, closing of an object and/or selection of an object other than an object under current user interaction. To illustrate, in the context of gaming example mentioned above, the play, pause and stop functions are controls that might change the object that is being interacted with or disrupt the current interaction. The gaming application could be disrupted if either of these controls (play, pause and stop functions) is selected by a user.

To provide another illustration of disruptive controls, let's consider a photo sharing application on a computing device. In this case, interaction controls related to opening of a photo collection, closing of a photo collection and selection of a photo collection other than the collection under current interaction (on display) could be considered as disruptive controls. These controls might be categorized into a first level of user interaction controls and assigned to a single user amongst multiple users who could be viewing the photo sharing collections in each other's presence.

To provide a yet another illustration of disruptive controls, let's consider a video application on a computing device. In this case, interaction controls related to opening of a video, closing of a video and selection of a video other than the video under current interaction (on display) could be considered as disruptive controls.

In an example, the classification of user interaction controls related to an object into multiple levels of control may be made by the computing device. In this case, a computing device could be pre-configured or pre-programmed to classify user interaction controls related to an object into multiple levels of control. In another example, however, the classification of user interaction controls related to an object into multiple levels of control may be configurable at the option of a user of the computing device. That is it is left to the choice of a user(s) to decide which interaction controls related to an object may be classified into a first level of controls, a second level of controls, a third level of controls, and so and so forth.

In an example, a first level of user interaction control related to an object is assigned to a user, amongst other co-present users, who is first to begin an interaction with the computing device. To illustrate, let's consider the gaming scenario mentioned earlier. Let's also assume that user interaction controls related to the gaming application have been already divided into two levels of controls. First level of controls includes the play, pause and stop functions, and a second level of controls includes the colour (of an object) selection and sound selection functions. In the present case, upon recognition of multiple user presence by the computing device, the first level of controls is assigned to a user who is first to begin an interaction with the computing device. The first interaction may be carried by performing a gesture, providing a speech command, etc. to the computing device.

In another example, a first level of user interaction controls related to an object may be assigned to a registered user of the computing device. The computing device may recognise a registered user from its records or an external database and assign the first level of user interaction control to the registered user.

In a yet another example, a first level of user interaction controls related to an object may be assigned based on the position of a user relative to the computing device. The computing device may recognise a user's position (for example, far or near, right or left, etc.) relative to its own location and assign the first level of user interaction controls to the recognized user.

In a further example, first level of user interaction controls related to an object may be assigned based on a demographic analysis of co-present simultaneous users of the computing device. To provide an illustration, the computing device, upon recognition of co-present users, may perform a demographic analysis on the user group. In an instance, the analysis may help the device identify an adult in a group of child users. Upon identification, the first level of user interaction control related to an object (for e.g., a gaming application) may be assigned to the adult person.

In a still further example, a first level of user interaction controls related to an object may assigned by the computing device or a user of the computing device. Apart from classifying the user interaction controls into multiple levels in the first place, the first level of user interaction controls related to an object may be assigned by the computing device or at the option of a user of the computing device.

In another example, a first level of user interaction controls related to an object may be shared with another co-present simultaneous user of the computing device. A user who was first assigned the first level of controls related to an object may share it with another co-present user.

In a still another example, first level of user interaction controls related to an object may be transferred to another co-present simultaneous user of the computing device. A user who was first assigned the first level of controls related to an object transfer it with another co-present user.

Block 120 involves assigning a second level of user interaction controls related to the object to all co-present simultaneous users of the computing device.

Once the first level of user interaction controls related to an object on a computing device is assigned, the method assigns a second level of user interaction controls related to the object to all co-present simultaneous users of the computing device. Whereas the first level of user interaction controls is assigned to one individual, the second level of user interaction controls is assigned to all co-present users of the computing device.

To illustrate with the help of gaming application example mentioned earlier, the second level of user interaction controls may include the colour (of an object) selection function and the sound selection function. These controls are assigned to all co-present simultaneous users.

In an example, the second level of user interaction controls includes non-disruptive controls, which may not interrupt a user's interaction with the object. The non-disruptive controls might be labelled “Somntrols”. The non-disruptive controls may include commands related to manipulation of an object. To illustrate, in the gaming example, the interaction controls related to a colour (of an object) selection function or sound selection function do not disrupt a user's interaction with the object. They simply help with manipulating ancillary functions. A colour (of an object) selection may help any co-present user select a colour of the object under interaction without disrupting multiple user interaction. For instance, if a car race is being played as part of a gaming application, selecting another colour of the car by a co-present user may not disrupt the racing interaction.

To provide another illustration of non-disruptive control, let's consider the photo sharing application mentioned earlier. In this case, interaction controls related to zoom-in function, zoom-out function, contrast-selection function, crop-selection function, etc. could be considered as non-disruptive controls. These controls might be categorized into a second level of user interaction controls and assigned to all co-present users who might use them without interfering with the original or current interaction.

To provide another illustration of non-disruptive controls, let's consider the video application mentioned earlier. In this case, interaction controls related to volume control, resizing of video display window function, contrast function, etc. could be considered as non-disruptive controls. These controls might be categorized into a second level of user interaction controls.

Whether it is a first level of user interaction controls or a second level of user interaction controls, both levels include at least one command that allows manipulation of an object on the computing device.

In an example, once the first and second level of user interaction controls related to an object (present on a computing device) have been assigned, the method allows the computing device to receive commands corresponding to the first level of user interaction control from the user who was assigned these interaction controls in the first place. The method also enables the device to receive commands related to second level of user interaction control from all co-present simultaneous users of the computing device. In an example, the user commands may be given, by way of illustration, and not limitation, as speech commands, gesture-based commands, touch commands, etc.

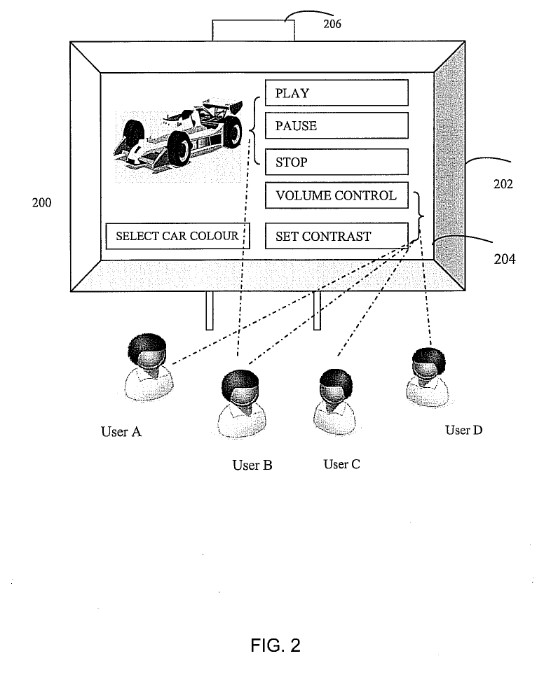

FIG. 2 shows an example of assigning user interaction controls related to an object, according to an embodiment.

In an example, the system 200 of FIG. 2 includes a number of users (User A, User B, User C and User D) interacting with a computing device 202. The users (User A, User B, User C and User D) are co-present simultaneous users of the computing device 202. The computing device 202 is coupled to a display device 204 and sensor 206.

The computing device 202, may be, but not limited to, a personal computer, a desktop computer, a laptop computer, a notebook computer, a network computer, a personal digital assistant (PDA), a mobile device, a hand-held device, or the like. The computing device 202 is described in detail later in connection with FIG. 3.

Sensor 206 may be used to recognize various input modalities of a user(s). Depending upon the user input modality to be recognized, the sensor 206 configuration may vary. If gestures or gaze of a user needs to be recognized, sensor 206 may include an imaging device along with a corresponding recognition module, i.e. a gesture recognition module and/or gaze recognition module. In case, the user input modality is speech, sensor 206 may include a microphone along with a speech recognition module. The imaging device may be a separate device, which may be attachable to the computing device 202, or it may be integrated with the computing system 202. In an example, the imaging device may be a camera, which may be a still camera, a video camera, a digital camera, and the like.

The display device 204 may include a Virtual Display Unit (VDU) for displaying an object present on the computing device 202.

In an example, multiple users (User A, User B, User C and User D) come together to use the computing device 202 simultaneously. Let's assume that the users (User A, User B, User C and User D) want to play a computer game using a gaming application, which is residing on the computing device 202. Upon activation, the gaming application, with its user interaction controls, is displayed on device 204.

The computing device 202 recognizes the physical co-presence of users (User A, User B, User C and User D) with the help of sensor 206. Once the physical co-presence of users (User A, User B, User C and User D) is recognized, the computing device 202 assigns a first level of user interaction controls related to the gaming application to a single user (let's assume User B) and a second level of user interaction controls related to the gaming application to all co-present simultaneous users (User A, User B, User C and User D) of the computing device. For instance, controls, PLAY, PAUSE and STOP, are categorized into a first level of user interaction controls, and assigned to User B. On the other hand, controls, such as, VOLUME CONTROL and SET CONTRAST are assigned to all co-present simultaneous users (User A, User B, User C and User D).

The division of interaction controls related to an object into multiple levels and their subsequent assignment to different set of individuals minimizes the extent of conflicting simultaneous inputs issued to a computing device, and also limits chaos and breakdown situations.

FIG. 3 shows a block diagram of a computing system according to an embodiment.

The system 300 may be a computing device, such as, but not limited to, a personal computer, a desktop computer, a laptop computer, a notebook computer, a network computer, a personal digital assistant (PDA), a mobile device, a hand-held device, or the like.

System 300 may include a processor 310, for executing machine readable instructions, a memory 312, for storing machine readable instructions (such as, a module 314), an input interface 316 and an output device 318. These components may be coupled together through a system bus 320.

Processor 310 is arranged to execute machine readable instructions. The machine readable instructions may comprise a module for assigning, in a scenario where multiple co-present users are simultaneously providing user inputs to a computing device, a first level of user interaction controls related to an object on the computing device to a single user; assigning a second level of user interaction controls related to the object to all co-present simultaneous users of the computing device, wherein the first and the second level of user interaction controls include at least one command that allows manipulation of the object on the computing device. Processor 310 may also execute modules related to gesture recognition of a user, voice recognition of a user and/or biometric recognition of user.

It is clarified that the term “module”, as used herein, means, but is not limited to, a software or hardware component. A module may include, by way of example, components, such as software components, processes, functions, attributes, procedures, drivers, firmware, data, databases, and data structures. The module may reside on a volatile or non-volatile storage medium and configured to interact with a processor of a computer system.

The memory 312 may include computer system memory such as, but not limited to, SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. The memory 312 may include a module 314. It may also act as a storage medium that stores virtual media identified by a user(s).

The input interface (input system) 316 may include the sensor 206. The interface may be an imaging device (for example, a camera), a biometric interface, a mouse, a key pad, a touch pad, a touch screen, a microphone, a gesture recognizer, a speech recognizer, a gaze recognizer and/or a lip movement recognizer. The interface 316 collects input from a user(s). The input interface 316 receives control commands corresponding to first level of user interaction control from a user assigned with the first level of user interaction controls and commands related to second level of user interaction control from all co-present simultaneous users of the computing device.

The output device 318 may include a Virtual Display Unit (VDU) 204 (of FIG. 2) for displaying, inter alia, an object present on the computing device. The output device 318 also that displays assignment of a first level of user interaction controls related to an object on a computing device, to a user co-present with other simultaneous users of the computing device, in form of a graphical user interface (GUI).

It would be appreciated that the system components depicted in FIG. 3 are for the purpose of illustration only and the actual components may vary depending on the computing system and architecture deployed for implementation of the present solution. The various components described above may be hosted on a single computing system or multiple computer systems, including servers, connected together through suitable means.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present solution.

1. A computer implemented method of assigning user interaction controls related to an object on a computing device, comprising:
assigning, in a scenario where multiple co-present users are simultaneously providing user inputs to a computing device, a first level of user interaction controls related to an object on the computing device to a single user;
assigning a second level of user interaction controls related to the object to all co-present simultaneous users of the computing device,
wherein the first and the second level of user interaction controls include at least one command that allows manipulation of the object on the computing device.

2. The method of claim 1, wherein the first level of user interaction controls includes disruptive controls, which are capable of interrupting a user's interaction with the object.

3. The method of claim 2, wherein disruptive controls include commands related to opening of an object, closing of an object and/or selection of an object other than an object under current user interaction.

4. The method of claim 1, further comprising classifying user interaction controls related to an object into multiple levels of control, wherein the classification is made by the computing device or configurable by a user of the computing device.

5. The method of claim 1, wherein the first level of user interaction control related to the object is assigned to a user, amongst other co-present users, who is first to begin an interaction with the computing device.

6. The method of claim 1, wherein the first level of user interaction control related to the object is assigned to a registered user of the computing device.

7. The method of claim 1, wherein the first level of user interaction control related to the object is assigned based on a demographic analysis of co-present simultaneous users of the computing device.

8. The method of claim 1, wherein the first level of user interaction control related to the object is assigned by the computing device or a user of the computing device.

9. The method of claim 1, wherein the first level of user interaction control related to the object is shareable with another user amongst co-present simultaneous users of the computing device.

10. The method of claim 1, wherein the first level of user interaction control related to the object is transferable to another user amongst co-present simultaneous users of the computing device.

11. The method of claim 1, further comprising:
receiving commands corresponding to first level of user interaction control from the user who was assigned the first level of user interaction controls; and
receiving commands related to second level of user interaction control from all co-present simultaneous users of the computing device.

12. A system comprising:
a processor that executes machine readable instructions to:
assign a first level of user interaction controls related to an object on a computing device, to a user co-present with other simultaneous users of the computing device; and
assign a second level of user interaction controls related to the object to all co-present simultaneous users of the computing device,
wherein the first and the second level of user interaction controls include at least one command that allows manipulation of the object on the computing device.

13. The system of claim 12, further comprising:
a display device that displays assignment of a first level of user interaction controls related to an object on a computing device, to a user co-present with other simultaneous users of the computing device, in form of a graphical user interface (GUI).

14. The system of claim 12, further comprising:
an input system to receive control commands corresponding to first level of user interaction control from the user assigned with the first level of user interaction controls; and
receiving commands related to second level of user interaction control from all co-present simultaneous users of the computing device.

15. The system of claim 13, wherein the input system comprises at least one of sensors for recognition of a gesture command, a speech command and face recognition of a user of the computing device.
